(19) United States
(12) Patent Application Publication
(10) Pub. No.: US 2015/0109238 A1
(43) Pub. Date: Apr. 23, 2015

(54) TOUCH PANEL

(71) Applicant: HANNSTOUCH SOLUTION INCORPORATED, Tainan City (TW)

(72) Inventors: Ming-Liang CHEN, Tainan City (TW); Ching-Feng TSAI, Tainan City (TW)

(73) Assignee: HANNSTOUCH SOLUTION INCORPORATED, Tainan City (TW)

(21) Appl. No.: 14/251,642

(22) Filed: Apr. 13, 2014

(30) Foreign Application Priority Data
Oct. 18, 2013 (TW) 102137723

(51) Int. Cl. G06F 3/046

(52) U.S. Cl. CPC G06F 3/046; G06F 2203/04112
USPC 345/174

(57) ABSTRACT

A touch panel includes a substrate, a transparent conductive sensing layer, and a metal sensing layer. The substrate has a first surface and a second surface opposite to each other. The first surface is close to an operating surface of the touch panel, and the second surface is away from the operating surface of the touch panel. The transparent conductive sensing layer is disposed on the first surface and has plural first electrode patterns. The metal sensing layer is disposed on the second surface and has plural second electrode patterns, in which the second electrode patterns form a metal mesh structure. The first electrode patterns and the second electrode patterns define a sensing unit array.

### RELATED APPLICATIONS

This application claims priority to Taiwan Application Serial Number 102137723, filed Oct. 18, 2013, which is herein incorporated by reference.

### BACKGROUND

1. Field of Invention

The present invention relates to a touch panel. More particularly, the present invention relates to a touch panel having a transparent conductive sensing layer and a metal sensing layer.

2. Description of Related Art

In the recent years, thin flat-panel displays have become popular in the various applications of electronic devices. For the purposes of use convenience, concise appearances and multifunction, the input devices of the electronic devices such as information products have changed to touch panels from mouse, keyboards and other traditional input devices.

As the development of the flat-panel displays and the touch input devices, for users enjoying bigger visual screens and easier operation modes in limited spaces, some electronic products integrate the touch panel and the display panel to form a touch display panel.

In principle, when a conductive object (such as a finger(s)) contacts the touch-sensing array of a touch panel, the electronic characteristics (such as resistance or capacitance) of the touch-sensing array change, which causes a change in the potential difference of the touch-sensing array. The change of the electronic characteristic results in transmitting a controlling signal to the outer controlling circuit board, and the signal can be computed and analyzed by a processor to obtain results. Next, the outer controlling circuit board sends a displaying signal to the display panel, by which an image is displayed before the users.

Since the touch panel is disposed over the display panel, the electrodes or the conductive wires of the touch panel have been made from transparent conductive materials. However, the transparent conductive materials have higher resistance, which limits the applications of the touch panels in larger size. To address the limitation, metal conductive meshes have been applied but may blur the images due to a Moiré phenomenon from the overlapping thin wires of the metal meshes.

### SUMMARY

According to one aspect of the present invention, a touch panel includes a substrate, a transparent sensing layer, and a metal sensing layer. The substrate includes a first surface and a second surface opposite to each other, in which the first surface is close to an operating surface of the touch panel, and the second surface is away from the operating surface of the touch panel. The transparent conductive sensing layer is disposed on the first surface and includes plural of first electrode patterns. The metal sensing layer is disposed on the second surface and includes plural second electrode patterns. The second electrode patterns form a metal mesh structure, and the first electrode patterns and the second electrode patterns define a sensing unit array.

According to another aspect of the present invention, a touch panel includes a substrate, a transparent sensing layer, a metal sensing layer, and an engagement element. The substrate includes a first surface and a second surface opposite to each other, in which the first substrate is close to an operating surface of the touch panel, and the second substrate is away from the operating surface of the touch panel. The transparent conductive sensing layer is disposed on and contacting the second surface, the transparent conductive sensing layer including plural first electrode patterns. The metal sensing layer includes plural second electrode patterns, in which the second electrode patterns form a metal mesh structure, and the first electrode patterns and the second electrode patterns define a sensing unit array. The transparent conductive sensing layer and the metal sensing layer are engaged through the engagement element.

This disclosure provides a touch panel using the transparent conductive material and the metal conductive material simultaneously, so that the problem of high resistance occurred traditionally by using transparent conductive material can be solved effectively, and the Moiré phenomenon occurred due to the overlapping of the wires of metal meshes in traditional designs can be lowered.

Furthermore, in the touch panel of the present disclosure, the transparent conductive sensing layer is close to the operating surface, and the metal sensing layer is away from the operating surface. As a result, the noise generated from the transparent conductive sensing layer has less influence on the electronic devices under the touch panel. The metal sensing layer between the transparent conductive sensing layer and the electronic devices can provide a shielding effect.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows

FIG. 1 is a cross-sectional view of the touch panel according to one embodiment of the present invention;

FIG. 2A is a schematic view of the touch panel viewed from the first surface according to one embodiment of the present invention;

FIG. 2B is a schematic view of the touch panel viewed from the second surface according to one embodiment of the present invention; and

FIG. 3 to FIG. 9 are cross-sectional views of the touch panel according to various embodiments of the present invention respectively.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

For touch panels, especially for the touch panels with large sizes, using transparent conductive material as electrodes and conductive wires may result in over high resistance. However, metal meshes with a lower resistance may blur the images due to a Moiré phenomenon from the overlapping wires at the arrangement of the display panel. This invention provides a touch panel mixing the transparent conductive material and the metal conductive material in order to solve the problem of high resistance or the Moiré phenomenon in the traditional touch panel.

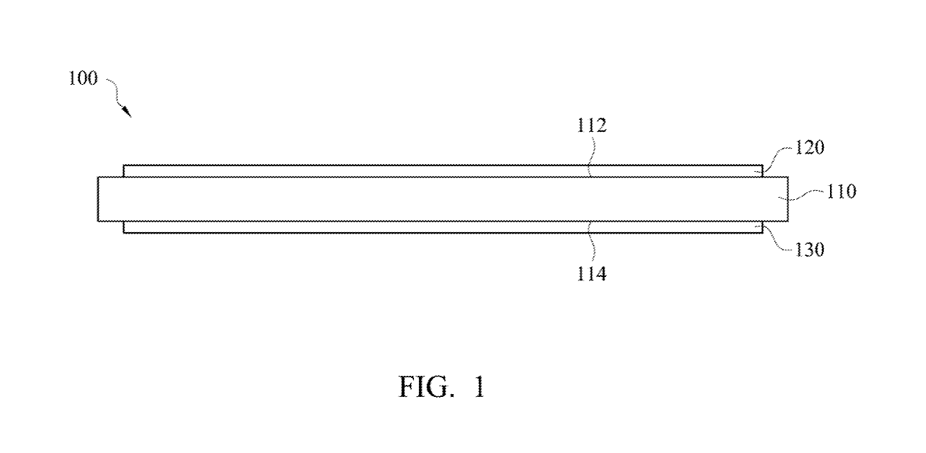

Reference is made to FIG. 1. FIG. 1 is a cross-sectional view of the touch panel according to one embodiment of the present invention. A touch panel 100 includes a substrate 110, a transparent conductive sensing layer 120, and a metal sensing layer 130. The touch panel 100 has an operating surface, on which the fingers or the styluses can slide for sending the operating commands. The substrate 110 has a first surface 112 and a second surface 114, in which the first surface 112 is close to the operating surface of the touch panel 100, and the second surface 114 is away from the operating surface of the touch panel 100. In other words, at the operation of the touch panel 100, the first surface 112 is close to users, and the second surface 114 is away from users.

The transparent conductive sensing layer 120 and the metal sensing layer 130 are respectively disposed on the two opposite sides of the substrate 110, in which the transparent conductive sensing layer 120 is disposed on the first surface 112, and the metal sensing layer 130 is disposed on the second surface 114 In other words, at the operation of the touch panel, the transparent conductive sensing layer 120 is close to users, and the metal sensing layer 130 is away from users. The transparent conductive sensing layer 120 has plural first electrode patterns, and the metal sensing layer 130 has plural second electrode patterns. The first electrode patterns and the second electrode patterns define plural sensing units.

The material of the transparent conductive sensing layer 120 can be transparent conductive oxide (TCO), such as indium tin oxides, zinc oxides, aluminum doped zinc oxides, gallium doped zinc oxides, indium doped zinc oxides, graphene, or other transparent conductive materials. The transparent conductive sensing layer 120 can be formed on the substrate 110 by lithography. The materials of the metal sensing layer 130 includes chromium, molybdenum, silvers, aluminum, coppers, nanometals (such as nano silvers), and other metals or the compositions of them. The metal sensing layer 130 can be a metal mesh structure, in which a diameter of the wires is about from 2 micrometers to 8 micrometers, and the surface of the metal sensing layer 130 can be manipulated by a blackening process. For example, the metal sensing layer 130 has an anti-reflection layer to reduce the reflectance of the metals. The metal sensing layer 130 can be formed on the substrate 110 by lithography, gravure, or roll-to-roll fabrication. The substrate 110 can be a rigid substrate with a thickness from 0.4 millimeters to 2 millimeters, and the materials of the rigid substrate can be glass, acrylic, polyethylene terephthalate (PET), polymethyl methacrylate (PMMA), or other material. On the other hand, the substrate 110 can be a flexible substrate with a thickness from 0.01 millimeters to 0.3 millimeters, and the materials of the flexible substrate can be plastic films or other materials.

In the touch panel 100, the transparent conductive sensing layer 120 and the metal sensing layer 130 are mixed and used. As a result, comparing to the traditional touch panels merely using transparent conductive materials, the touch panel 100 in this invention has a lower resistance. Comparing to the traditional touch panels only using metals, the touch panel 100 disclosed in the present invention reduces the occurrence of the Moiré phenomenon.

Furthermore, in a test of the transparent conductive sensing layer 120, the noise generated from the transparent conductive sensing layer 120 is higher than the noise generated from the metal sensing layer 130. Therefore, when the transparent conductive sensing layer 120 is disposed on the first surface 112 of the substrate 110, the transparent conductive sensing layer 120 is away from the electronic devices under the touch panel 100, such as display panels or processing units. As a result, the electronic devices under the touch panel 100 are prevented from being interfered by the noise of the transparent conductive sensing layer 120. In addition, the metal sensing layer 130 is disposed on the second surface 114 of the substrate 110 between the transparent conductive sensing layer 120 and the electronic devices under the touch panel 100. Therefore, the metal sensing layer 130 can further provide a shielding effect to lower the effect of the noise generated from the transparent conductive sensing layer 120.

The transparent conductive sensing layer 120 and the metal sensing layer 130 can be the electrodes of the touch panel 100 in the directions of two axis, such as electrodes in the directions of y-axis and x-axis. Furthermore, the electrodes in the directions of y-axis and x-axis are formed by the first electrode patterns and the second electrode patterns with a shape of diamond. The second electrode patterns of the metal sensing layer 130 better form a metal mesh structure, and the illustrations are accompanied by the followings drawings.

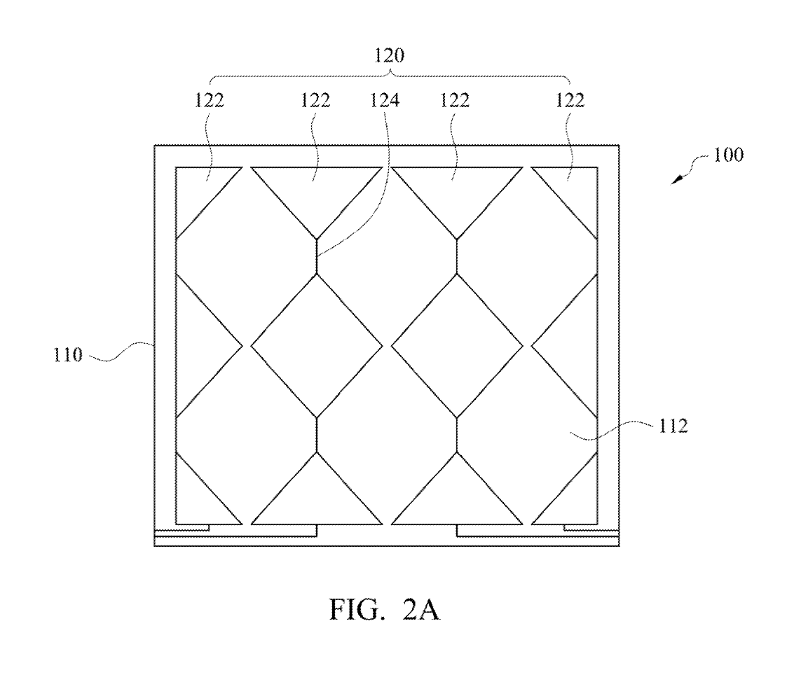

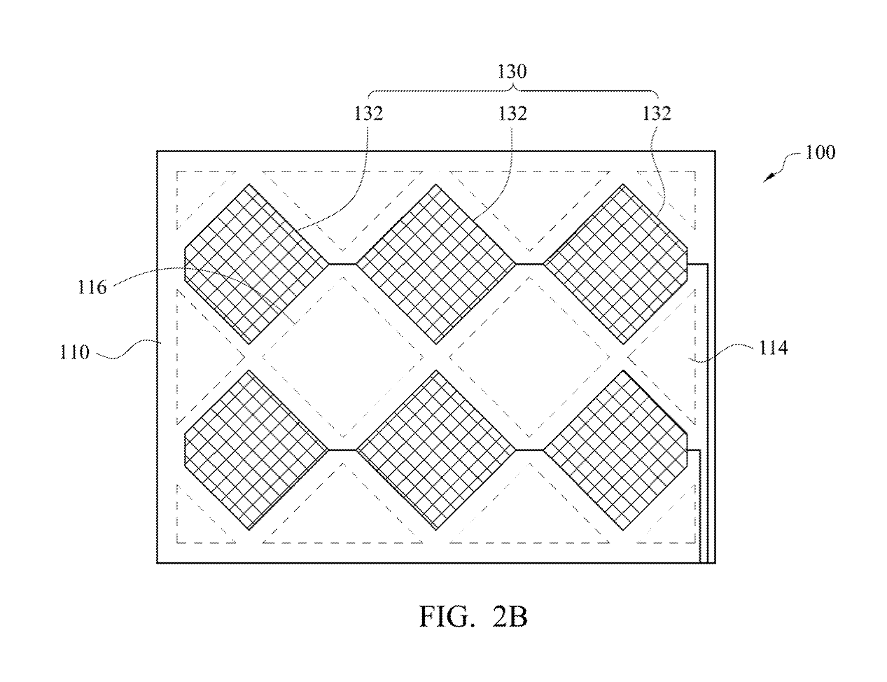

FIG. 2A is a schematic view of the touch panel 100 viewed from the first surface 112 according to one embodiment of the present invention. FIG. 2B is a schematic view of the touch panel 100 viewed from the second surface 114 according to one embodiment of the present invention. It is noted that the arrangements of the transparent conductive sensing layer 120 and the metal sensing layer 130 are illustrated in FIG. 2A and FIG. 28. However, the actual ratio or the numbers should not be deemed as the drawings.

Reference is made to FIG. 2A. The transparent conductive sensing layer 120 is disposed on the first surface 112 of the substrate 110, which is close to one side of the operating surface of the touch panel 100. The transparent conductive sensing layer 120 includes plural first electrode patterns 122 which are arranged in rows and parallel to each other along a first direction. In other words, the first electrode patterns 122 are series connected as multiple rows along the vertical direction in the drawing. In this embodiment, the first electrode patterns 122 are in a shape of diamond. However, in other embodiments, the first electrode patterns 122 can be in other shapes, such as a shape of long bar. In addition, the first electrode patterns 122 can be electrically connected by conductive wires 124, and the materials of the conductive wires 124 can be transparent conductive materials or opaque conductive materials.

Reference is made to FIG. 2B. The metal sensing layer is disposed on the second surface 114 of the substrate 110, which is one side away from the operating surface of the touch panel 100. The metal sensing layer 130 includes plural second electrode patterns 132, which are arranged in columns and parallel to each other along a second direction. The second direction is orthogonal to the first direction. In other words, the second electrode patterns 132 are series connected as multiple columns along the horizontal direction in the drawing. The materials of the second electrode patterns 132 are metals, and the second electrode patterns 132 form a metal mesh structure including metal thin wires. In this embodiment, the second electrode patterns 132 are in a shape of diamond. However, in other embodiments, the second electrode patterns 132 can be in other shapes coordinating with the first electrode patterns 122, such as a shape of long bar. The diamond-shaped patterns include a frame constructed by the metal thin wires and the latticed metal wires inside the frame, and the metal wires can be straight lines, wave lines (regularly curved lines), or irregularly curved lines.

Reference is now made to both FIG. 2A and FIG. 26. The first electrode patterns 122 and the second electrode patterns 132 are disposed on the first surface 112 and the second surface 114 of the substrate 110 respectively, so that the first electrode patterns 122 and the second electrode patterns 132 are prevented from the direct contact, which may lead to a short circuit. The conductive wires 124 used for connecting the first electrode patterns 122 can be treated as a bridge area, so that the first electrode patterns 122 of the transparent conductive sensing layer 120 act as the electrodes along the y-axis, and the second electrode patterns 132 of the metal sensing layer 130 act as the electrodes along the x-axis.

The second electrode patterns 132 are spaced by plural spaces 116, and the spaces 116 are substantially in a shape of diamond. Vertical projections of the first electrode patterns 122 on the second surface 114 are located at the spaces 116, and the second electrode patterns 132 are not overlapped with the vertical projections. As a result, the first electrode patterns 122 and the second electrode patterns 132 are alternatingly arranged and define a sensing unit array.

The shape of the first electrode patterns 122 and the second electrode patterns 132 are not limited to the diamonds, and the first electrode patterns 122 and the second electrode patterns 132 are not limited to be orthogonal arranged with each other. A person skilled in the art can adjust the details of this invention in accordance with the actual demands of designs.

The structure of the transparent conductive sensing layer and the metal sensing layer are illustrated in FIG. 2A and FIG. 2B. In the following embodiments, illustrations are focused on the lamination of the touch panel, and the details of the transparent conductive sensing layer and the metal sensing layer are omitted.

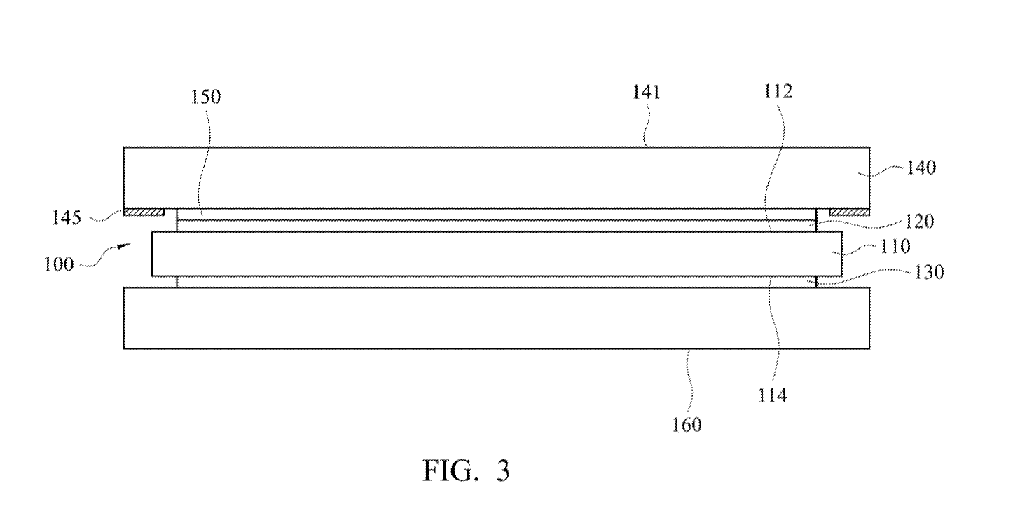

Reference is made to FIG. 3. FIG. 3 is a cross-sectional view of the touch panel 100 according to one embodiment of the present invention. The touch panel 100 includes a substrate 110, a transparent conductive sensing layer 120 disposed on a first surface 112 of the substrate 110, and a metal sensing layer 130 disposed on a second surface 114 of the substrate 110. The substrate 110 can be a rigid substrate or a flexible substrate. As described above, the thickness of the rigid substrate may be from 0.4 millimeter to 2 millimeter, and the thickness of the flexible substrate may be from 0.01 millimeter to 0.3 millimeter.

The touch panel 100 can selectively include a protective substrate 140 disposed on the substrate 110, and the protective substrate 140 is close to the first surface 112 of the substrate 110. A light-shielding layer 145 facing the transparent conductive sensing layer 120 is disposed around the edges of the protective substrate 140 for shielding the wiring around the touch panel 100. The light-shielding layer 145 can be a black photoresist layer or other opaque material. The touch panel 100 further includes an optical clear adhesive 150 used for binding the protective substrate 140 and the transparent conductive sensing layer 120 together. The protective substrate 140 can be a rigid substrate, such as a tempered glass.

In this embodiment, the protective substrate 140 is the closest element to the users in the touch panel 100, and a top surface 141 of the protective substrate 140 acts as the operating plane of the touch panel 100. Users can use fingers or styluses to slide on the protective substrate 140, so that the sensing unit array defined by the transparent conductive sensing layer 120 and the metal sensing layer 130 detects the corresponding action and sends the commands to the processing units.

The touch panel 100 can be coordinated with a display panel 160, and the touch panel 100 and the display panel 160 constitute a touch display module. The touch display module provides images through the display panel 160, and users can operate in accordance with the displayed images. The display panel 160 can be an electronic device having a display function, such as a liquid crystal display panel, an organic light emitting display panel, or an electronic paper.

As described above, by disposing the transparent conductive sensing layer 120 at the first surface 112 of the substrate 110, the transparent conductive sensing layer 120 is away from the electronic devices under the touch panel 100, such as the display panel 160 or processing units. As a result, the noise generated from the transparent conductive sensing layer 120 has a less effect on the electronic devices under the touch panel 100. Apart from this, the metal sensing layer 130 is disposed between the transparent conductive sensing layer 120 and the electronic devices under the touch panel 100, so that the metal sensing layer 130 can further provide a shielding effect to lower the noise generated form the transparent conductive sensing layer 120.

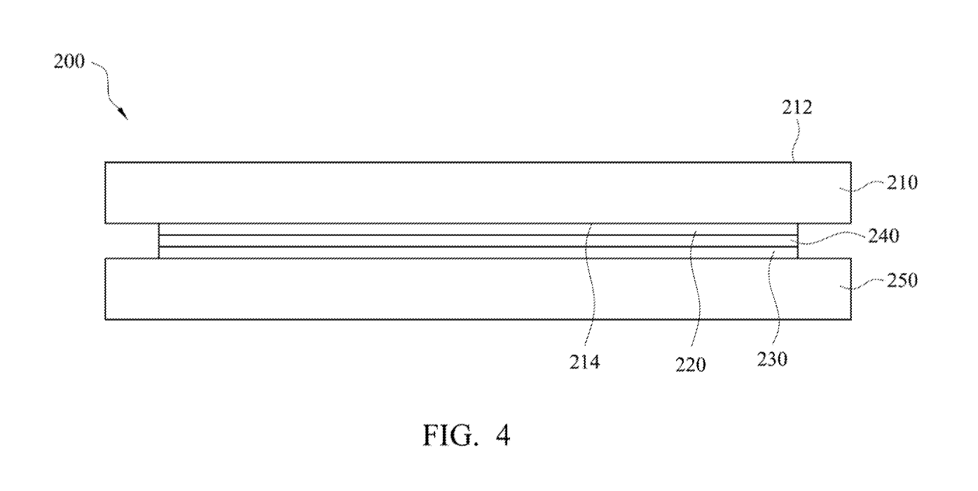

Reference is made to FIG. 4. FIG. 4 is a cross-sectional view of the touch panel 100 according to another embodiment of the present invention. The difference between this embodiment and the previous embodiment is the arrangement of the transparent conductive sensing layer 220 and the metal sensing layer 230, which are face to face arranged on the same side of the substrate 210. The substrate 210 has a first surface 212 close to the operating surface and a second surface 214 away from the operating surface. The transparent conductive sensing layer 220 is disposed on the second surface 214 of the substrate 210, and the transparent conductive sensing layer 220 includes plural first electrode patterns arranged along a first axial direction. The metal sensing layer 230 includes plural second electrode patterns arranged along a second axial direction, and the second electrode pattern form a metal mesh structure. The transparent conductive sensing layer 220 and the metal sensing layer 230 are engaged by an engagement element.

In this embodiment, the substrate 210 can be a rigid substrate, such as a protective substrate made from reinforced glass fibers. In other words, the transparent conductive sensing layer 220 can be directly formed on the substrate 210, and at this time, a light-shielding layer (not shown in the figure) can be disposed around the edges of the substrate 210 for shielding the wiring around the touch panel 200 as the embodiment in FIG. 3. If the substrate 210 is a flexible substrate, the touch panel 200 can selectively include another protective substrate (not shown in the figure) disposed on the top of the substrate 210 for strengthening the overall structure and acting as an operating surface. As described above, a light-shielding layer facing the transparent conductive sensing layer 220 is disposed around the edges of the protective substrate for shielding the wiring around the touch panel 200.

The engagement element in this embodiment can be an insulating layer 240, the materials of which are better transparent and insulating, such as polyimides (PI) or transparent photoresists. In other words, the transparent conductive sensing layer 220 can be formed on the second surface 214 of the substrate 210 by lithography, and an insulating layer 240 then forms on the transparent conductive sensing layer 220. After that, the metal sensing layer 230 forms on the insulating layer 240. The insulating layer 240 can partially cover the transparent conductive sensing layer 220, such as the place where the conductive wires 124 disposed in FIG. 2A, and the insulating layer 240 only need to isolate the transparent conductive sensing layer 220 from the metal sensing layer 230. In other embodiments, the insulating layer 240 can completely cover the top of the transparent conductive sensing layer 220 for completely isolating the transparent conductive sensing layer 220 from the metal sensing layer 230.

The touch panel 200 can be put on a display panel 250 for constituting a touch display panel module with the display panel 250. The touch panel 200 can be put on the display panel 250 directly, or the touch panel 200 can be engaged with the display panel 250 by the optical clear adhesive. That is, the optical clear adhesive (not shown in the figure) is disposed between the metal sensing layer 230 and the display panel 250.

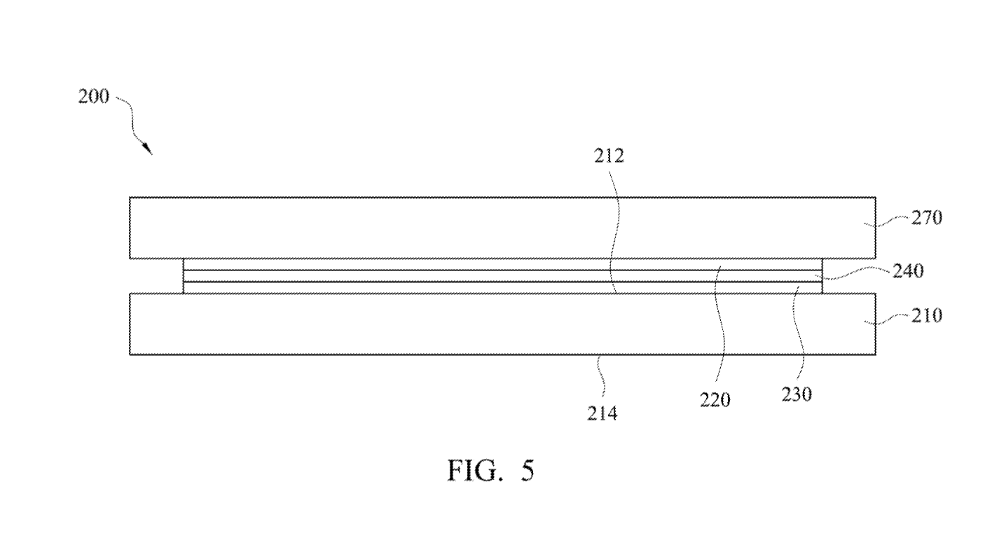

Reference is now made to FIG. 5. FIG. 5 is a cross-sectional view of the touch panel according to another embodiment of the present invention. A transparent conductive sensing layer 220 and a metal sensing layer 230 of the touch panel 200 are still face to face arranged on the same side of the substrate 210. The touch panel 200 includes a protective substrate 270.

The substrate 210 has a first surface 212 close to the operating surface and a second surface 214 away from the operating surface. The metal sensing layer 230 is disposed on the first surface 212 of the substrate 210, in which the transparent conductive sensing layer 220 includes plural first electrode patterns. The metal sensing layer 230 includes plural second electrode patterns, which form a metal mesh structure. The transparent conductive sensing layer 220 can be engaged with the metal sensing layer 230 by an engagement element, such as an insulating layer 240. The metal sensing layer 230 can be formed on the first surface 212 of the substrate 210 by lithography, then the insulating layer 240 forms on the metal sensing layer 230, and the transparent conductive sensing layer 220 forms on the insulating layer 240. The insulating layer 240 can partially cover the metal sensing layer 230, such as the place where the conductive wires 124 disposed in FIG. 2A, and the insulating layer 240 only needs to isolate the transparent conductive sensing layer 220 from the metal sensing layer 230. In other embodiments, the insulating layer 240 can completely cover the top of the metal sensing layer 230 for completely isolating the transparent conductive sensing layer 220 from the metal sensing layer 230. A protective substrate 270 can be fixed to the substrate 210 by the optical clear adhesive or other materials.

In other embodiments, the engagement element for binding the metal sensing layer 230 and the transparent conductive sensing layer 220 together can be the optical clear adhesive. As the engagement element being the optical clear adhesive, the transparent conductive sensing layer 220 is directly formed on the protective substrate 270, and the metal sensing layer 230 forms on the substrate 210. The protective substrate 270 having the transparent conductive sensing layer 220 and the substrate 210 having the metal sensing layer 230 are stick to each other through the optical clear adhesive.

In an embodiment, the substrate 210 can be a flexible substrate (the thickness can be from 0.01 millimeters to 0.3 millimeters) disposed on top of the substrate 210 for strengthening the whole structure and acting as an operating surface. Similarly, a light-shielding layer can be disposed around the edges of the protective substrate 270 for shielding the wiring around the touch panel 200.

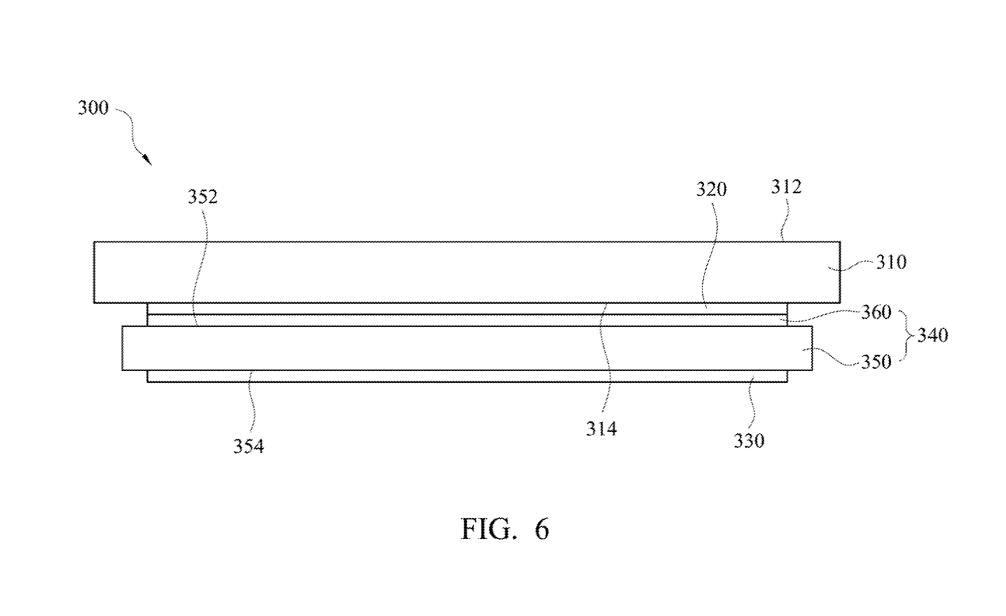

Reference is now made to FIG. 6. FIG. 6 is a cross-sectional view of the touch panel according to another embodiment of the present invention. A touch panel 300 includes a first substrate 310 having a first surface 312 close to the operating surface and a second surface 314 away from the operating surface. A transparent conductive sensing layer 320 is disposed on the second surface 314 of the first substrate 310, in which the transparent conductive sensing layer 320 includes plural first electrode patterns.

The touch panel 300 further includes a second substrate 350 having a third surface 352 close to the operating surface and a fourth surface 354 away from the operating surface. A metal sensing layer 330 is disposed on the fourth surface 354 of the second substrate 350, in which the metal sensing layer 330 includes plural second electrode patterns, and the second electrode patterns can form a metal mesh structure.

The first substrate 310 and the second substrate 350 can be bonded together through an optical clear adhesive 360. Moreover, the optical clear adhesive 360 is disposed between the transparent conductive sensing layer 320 and the third surface 352 of the second substrate 350. The transparent conductive sensing layer 320 and the metal sensing layer 330 are engaged through the second substrate 350 and the optical clear adhesive 360. As a result, the second substrate 350 and the optical clear adhesive 360 can be deemed as an engagement element 340 between the transparent conductive sensing layer 320 and the metal sensing layer 330.

The first substrate 310 can be a rigid substrate, which can be regarded as a protective substrate, such as a tempered glass. A light-shielding layer (not shown in the figure) facing the transparent conductive sensing layer 320 can be disposed around the edges of the first substrate 310 for shielding the wiring around the touch panel 300 as the embodiment in FIG. 3.

The transparent conductive sensing layer 320 is formed by lithography on the second surface 314 of the first substrate 310. The second substrate 350 can be a rigid substrate or a flexible substrate, and the metal sensing layer 330 is formed by lithography or gravure on the fourth surface 354 of the second substrate 350. After that, the first substrate 310 and the second substrate 350 are bonded together through the optical clear adhesive 360.

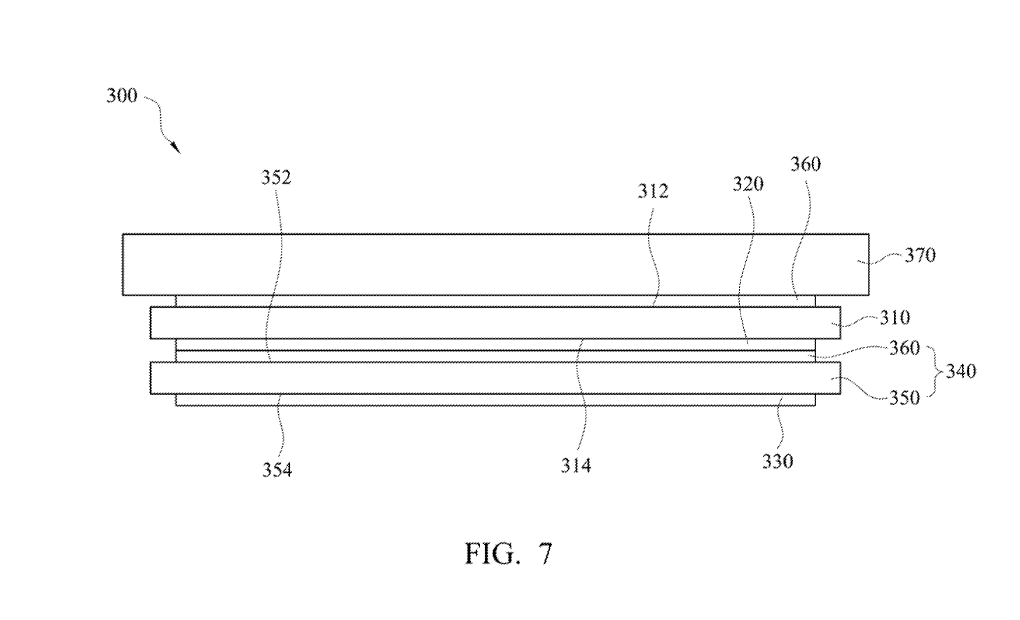

Reference is now made to FIG. 7. FIG. 7 is a cross-sectional view of the touch panel according to another embodiment of the present invention. The difference between this embodiment and the previous embodiment is that the first substrate 310 and the second substrate 350 can be flexible substrate. In this embodiment, the first substrate 310 and the transparent conductive sensing layer 320 constitute a film sensor, and the second substrate 350 and the metal sensing layer 330 constitute another film sensor. Then, the two film sensors are bonded to each other by the optical clear adhesive 360. The transparent conductive sensing layer 320 and the metal sensing layer 330 can be formed by the roll-to-roll fabrication respectively on the flexible first substrate 310 and the flexible second substrate 350. Comparing to lithography, the roll-to-roll fabrication using in this embodiment has advantages of the fast speed and low cost.

To protect the flexible first substrate 310, the flexible second substrate 350, and the wiring on the first substrate 310 and the second substrate 350, touch panel 300 can includes a protective substrate 370 disposed on the first surface 312 of the first substrate 310. The protective substrate 370 can be fixed to the first substrate 310 through the optical clear adhesive 360. A light-shielding layer (not shown in the figure) facing the transparent conductive sensing layer 320 can be disposed on the edges of the protective substrate 370 as the embodiment of FIG. 3 for shielding the wiring around the touch panel 300.

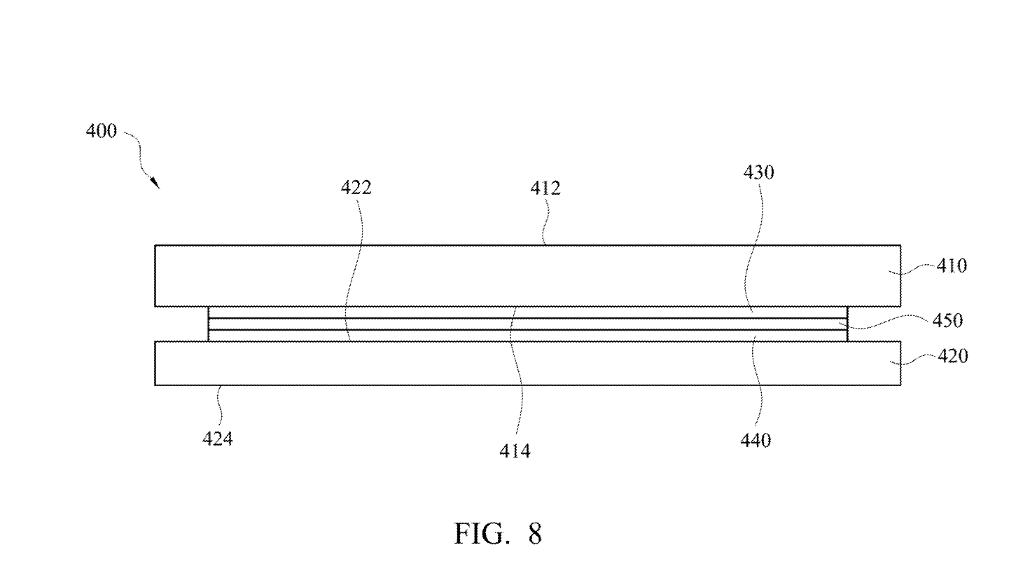

Reference is made to FIG. 8. FIG. 8 is a cross-sectional view of the touch panel according to another embodiment of the present invention The touch panel 400 includes a first substrate 410, a second substrate 420, a transparent conductive sensing layer 430, a metal sensing layer 440, and an optical clear adhesive 450. The first substrate 410 includes a first surface 412 close to the operating surface and a second surface 414 away from the operating surface. The transparent conductive sensing layer 430 is disposed on the second surface 414 of the first substrate 410. The second substrate 420 includes a third surface 422 close to the operating surface and a fourth surface 424 away from the operating surface. The metal sensing layer 440 is disposed on the third surface 422 of the second substrate 420. The first substrate 410 and the second substrate 420 are bonded together through an optical clear adhesive 450. Specifically, the optical clear adhesive 450 bonds the first substrate 410 and the second substrate 420 together.

The first substrate 410 can be a rigid substrate, such as a tempered glass, so that the first surface 412 of the first substrate 410 can directly act as the operating surface of the touch panel 400. A light-shielding layer (not shown in the figure) facing the transparent conductive sensing layer 430 is disposed around the edges of the first substrate 410 as the embodiment described in FIG. 3 for shielding the wiring around the touch panel 400.

The second substrate 420 can better be a flexible substrate, so that the metal sensing layer 440 can be formed on the fourth surface 424 of the second substrate 420 by the roll-to-roll fabrication for the fast fabrication and low cost.

In addition, in another embodiment, the first substrate 410 can also be a flexible substrate, so that the transparent conductive sensing layer 430 can be formed on the second surface 414 of the first substrate 410 by the roll-to-roll fabrication. Similarly, the touch panel 400 can include a protective substrate (not shown in the figure) disposed on top of the first substrate 410 for strengthening the overall structure and acting as the operating surface. The second substrate 420 can be a rigid substrate.

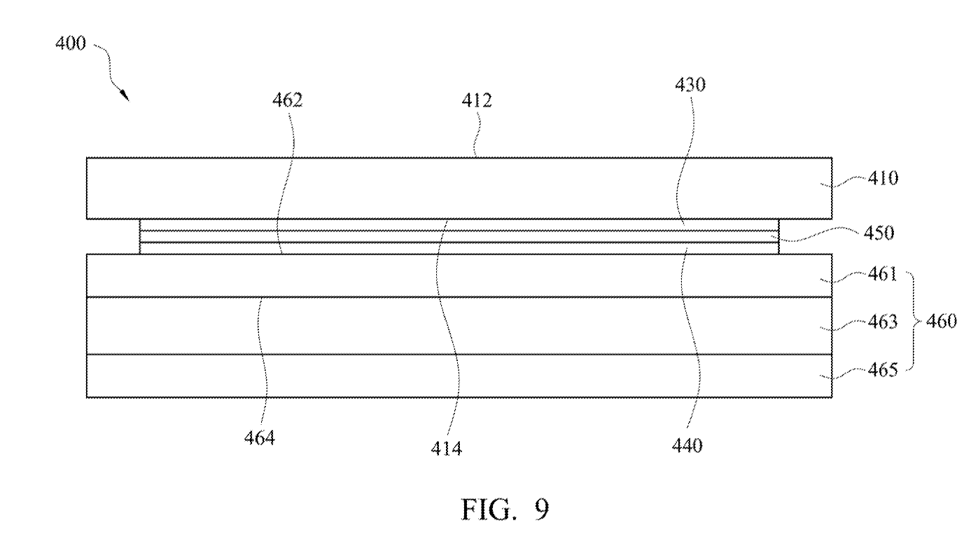

Reference is made to FIG. 9. FIG. 9 is a cross-sectional view of the touch panel according to another embodiment of the present invention. The difference between this embodiment and the previous embodiment is that the second substrate in this embodiment is a color filter plate 461 of the display panel 460. Specifically, the display panel 460 is a liquid crystal display panel, which includes a color filter plate 461, a liquid crystal layer 463, and a driving substrate 465 (such as a thin-film transistor driving substrate) from top to bottom. The color filter plate 461 has a third surface 462 close to the operating surface and a fourth surface 464 away from the operating surface. The metal sensing layer 440 is disposed on the third surface 462 of the color filter plate 461, and the color filter plate 461 includes red, blue, and green photoresists (not shown in the figure) on the fourth surface 464. In one embodiment, the metal sensing layer 440 can be directly formed on the third surface 462 of the color filter plate 461 by lithography or other methods. The first substrate 410 having the transparent conductive sensing layer 430 and the color filter plate 461 having the metal sensing layer 440 are bonded together through the optical clear adhesive 450. In another embodiment, the metal sensing layer 440 can be formed directly on the third surface 462 of the color filter plate 461 by lithography or other methods, then an insulating layer 450 is formed on the metal sensing layer 440, and the transparent conductive sensing layer 430 is formed on the insulating layer 450. The first substrate 410 is banded with the color filter plate 461 through the optical clear adhesive (not shown in the figure).

Directly forming the metal sensing layer 440 on the color filter plate 461 of the display panel 460 can reach the purposes of saving cost and designing the second electrode patterns on the metal sensing layer 440 in accordance with the lines of the display panel 460 (such as the route of the wires or the route of the black array). As a result, the metal wires of the second electrode patterns with the mesh structure are not directly overlapped with the wires of the display panel 460, and the Moiré phenomenon can be prevented.

As described in the above embodiment, in the touch panel of the present invention, the transparent conductive material and the metal material are used simultaneously to form a touch-sensing layer. Therefore, the problem of high resistances happened when using merely the transparent conductive material can be solved, and the Moiré phenomenon, which blurs images, occurred in the traditional metal mesh layer designs from the overlapping wires, can be prevented.

Above all, according to the touch panel of this invention, the transparent conductive sensing layer is disposed on one side close to the operating surface, and the metal sensing layer is disposed on the other side away from the operating surface. As a result, the noise generated from the transparent conductive sensing layer has less influence on the electronic devices under the touch panel, and the metal sensing layer disposed between the transparent conductive sensing layer and the electronic devices can further provides a shielding effect.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A touch panel, comprising:
a substrate comprising a first surface and a second surface opposite to each other, wherein the first surface is close to an operating surface of the touch panel, and the second surface is away from the operating surface of the touch panel;
a transparent conductive sensing layer disposed on the first surface and comprising a plurality of first electrode patterns; and
a metal sensing layer disposed on the second surface and comprising a plurality of second electrode patterns, wherein the second electrode patterns form a metal mesh structure, and the first electrode patterns and the second electrode patterns define a sensing unit array.

2. The touch panel of claim 1, wherein the first electrode patterns are arranged in rows and parallel to each other along a first direction, and the second electrode patterns are arranged in columns and parallel to each other along a second direction.

3. The touch panel of claim 2, wherein the second electrode patterns are spaced by a plurality of spaces, and a plurality of perpendicular projections of the first electrode patterns on the second surface are located at the spaces and not overlapped with the second electrode patterns

4. The touch panel of claim 1, wherein the first electrode patterns and the second electrode patterns are substantially in a shape of diamond.

5. The touch panel of claim 1, further comprising a color filter plate having a plurality of red, blue, and green photoresists thereon and the metal sensing layer disposed on the color filter plate, wherein the metal sensing layer is disposed between the transparent conductive sensing layer and the color filter plate.

6. The touch panel of claim 1, further comprising:
a protective substrate disposed on the substrate; and
an optical clear adhesive disposed between the protective substrate and the transparent conductive sensing layer, wherein the transparent conductive sensing layer is disposed between the protective substrate and the substrate.

7. The touch panel of claim 6, further comprising a light-shielding layer disposed around a plurality of edges of the protective substrate.

8. The touch panel of claim 6, wherein the protective substrate is a rigid substrate with a thickness from 0.4 millimeters to 2 millimeters, and the substrate is a flexible substrate with a thickness from 0.01 millimeters to 0.3 millimeters.

9. A touch panel, comprising:
a substrate comprising a first surface and a second surface opposite to each other, wherein the first surface is close to an operating surface of the touch panel, and the second surface is away from the operating surface of the touch panel;
a transparent conductive sensing layer disposed on and contacting the second surface, the transparent conductive sensing layer comprising a plurality of first electrode patterns;
a metal sensing layer comprising a plurality of second electrode patterns, wherein the second electrode patterns disposed under the transparent conductive sensing layer and form a metal mesh structure, and the first electrode patterns and the second electrode patterns define a sensing unit array; and
an engagement element disposed between the transparent conductive sensing layer and the metal sensing layer.

10. The touch panel of claim 9, wherein the second electrode patterns are spaced by a plurality of spaces, and a plurality of perpendicular projections of the first electrode patterns on the second surface are located at the spaces and not overlapped with the second electrode patterns.

11. The touch panel of claim 9, wherein the first electrode patterns and the second electrode patterns are substantially in a shape of diamond.

12. The touch panel of claim 9, wherein the engagement element is an insulating layer or an optical clear adhesive.

13. The touch panel of claim 9, further comprising: a color filter plate and the metal sensing layer disposed on the color filter plate, wherein the metal sensing layer is disposed between the transparent conductive sensing layer and the color filter plate.

14. The touch panel of claim 9, wherein the substrate is a first substrate, and the engagement element comprises:
a second substrate comprising a third surface and a fourth surface opposite to each other, wherein the third surface is close to the operating surface of the touch panel and is engaged with the transparent conductive sensing layer by an optical clear adhesive, the fourth surface is away from the operating surface of the touch panel, and the metal sensing layer is disposed on the fourth surface.

15. The touch panel of claim 14, wherein the second substrate is a flexible substrate, and the second substrate and the metal sensing layer form a first touch film, wherein the first touch film is fabricated by a roll-to-roll process.

16. The touch panel of claim 14, wherein the first substrate is a flexible substrate, the first substrate and the transparent conductive sensing layer form a second touch film, and the first substrate and the second substrate both have a thickness from 0.01 millimeter to 0.3 millimeter.

17. The touch panel of claim 16, further comprising:
a protective substrate disposed on the first substrate; and
an optical clear adhesive disposed between the protective substrate and the first surface of the first substrate.

18. The touch panel of claim 9, wherein the substrate is a first substrate and the engagement element is an insulating layer or an optical clear adhesive, and the touch panel comprises:
a second substrate comprising a third surface and a forth surface opposite to each other, wherein the third surface is close to the operating surface of the touch panel and the forth surface is away from the operating surface of the touch panel, the metal sensing layer is disposed on the third surface, and the optical clear adhesive or the insulating layer is disposed between the metal sensing layer and the transparent conductive sensing layer.

19. The touch panel of claim 18, wherein the second substrate is a flexible substrate, and the second substrate and the metal sensing layer form a first touch film.

20. The touch panel of claim 19, wherein the first substrate is a protective substrate, and a light-shielding layer is disposed around a plurality of edges of the first substrate.

21. The touch panel of claim 20, wherein the second substrate is a color filter plate comprising a plurality of red, blue, and green photoresists disposed on the fourth surface.

22. The touch panel of claim 19, wherein the first substrate is a flexible substrate, and the first substrate and the transparent conductive sensing layer form a second touch film, and the first substrate and the second substrate both have a thickness from 0.01 millimeter to 0.3 millimeter.
